(19) United States
(12) Patent Application Publication
(10) Pub. No.: US 2010/0076841 A1
(43) Pub. Date: Mar. 25, 2010

(54) ADVERTISEMENT REPOSITORY AND ADVERTISEMENT SEARCH

(75) Inventors: DATTATRAYA BABAN RAJPURE, REDMOND, WA (US); SREENIVAS GUKAL, SAMMAMISH, WA (US); NITIN KUMAR, BELLEVUE, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/234,313

(22) Filed: Sep. 19, 2008

(51) Int. Cl. G06Q 30/00; G06Q 90/00

(52) U.S. Cl. 705/14.49; 705/1

(57) ABSTRACT

A computer system, graphical user interface, and method to search for previously published advertisements are provided. The computer system includes an advertisement index, a search engine, and an advertisement platform. The advertisement index organizes the previously published advertisements based on a media publisher. The search engine allows a user to search for previously published advertisements. The advertisement platform provides the previously published advertisements to the search engine based on the search request that the users submit to the search engine.

### BACKGROUND

Conventionally, advertisements are published via traditional media, such as, print, radio, television, and Internet. The advertisements that are concise, catchy, and funny are more likely to capture the attention of a user, who may enter into a transaction for the good or service promoted by the advertisement. After viewing an advertisement published via the traditional media, a user that viewed or heard the advertisement may forget where or how to enter into a transaction for the good or service because many advertisements in traditional media are fleeting.

To recall an advertisement, a user may use conventional search engines, conventional Web forums, or conventional Web blogs to look for the advertisement or the goods or services promoted by the advertisements. The conventional search engines receive terms that describe the advertisement and search a Web index to return all indexed items that include the terms provided by the user. The conventional Web forums may include messages posted by various users about an advertisement, a good, or a service. The Web forums may not provide the actual advertisement that was published to the user or may be inaccurate because of human error. The Web blogs allow users to provide editorials regarding an advertisement, a good, or a service. The Web blogs may not provide the actual advertisement that was published to the user or may be inaccurate because of human error. Accordingly, the information or advertisements provided by the conventional search engines, conventional Web forums, or conventional Web blogs may not be relevant to the advertisement, good, or service the user is attempting to locate.

### SUMMARY

Embodiments of the invention include graphical user interfaces, computer systems, and computer-implemented methods to search for previously published advertisements.

The graphical user interfaces are generated for display to a user in response to a request received from the user. The graphical user interfaces may include search fields, display areas, and advertisement controls. The search fields receive user search terms for previously published advertisements. The search terms may include identifiers for non-advertisement content and a date the non-advertisement content was consumed by the user. The display areas provide results that include previously published advertisements that match the search terms. The advertisement controls limit the results based on categories corresponding to goods and services associated with the previously published advertisements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary computing environment for providing previously published advertisements, according to embodiments of the invention;

FIG. 2 illustrates an exemplary advertisement platform, according to embodiments of the invention;

FIG. 3 illustrates an exemplary graphical user interface, according to embodiments of the invention;

FIG. 4 illustrates an exemplary result set having previously published advertisements, according to embodiments of the invention; and

FIG. 5 illustrates an exemplary computer-implemented method for generating an advertisement index that provides result sets having previously published advertisements in response to a user request, according to embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “platform” refers to any combination of hardware, software, or firmware. Also, the term “competitor exclusion” refers to preferences received from an advertiser or inferred from the advertiser's advertisement context in traditional media, where the preference or advertisement context indicates that the advertiser chooses to prohibit publication of a competitors advertisement spatially or temporally proximate to the advertiser's advertisement.

Embodiments of the invention provide an advertisement platform that generates an advertisement index from advertisement logs associated with advertisement published in traditional media, such as, newspapers, magazines, television, and Internet. The advertisement index stores the advertisements or references to the advertisements. The advertisement index is used by a search engine to provide previously published advertisements to the user.

The search engine is configured to communicate to the advertisement platform to receive the previously published advertisements that match the search terms received from the user. The search engine may provide the user with advertisement controls that allow the user to locate similar advertisements on a single Web page or to limit the number of advertisements provided to the user. The user may employ the search engine to locate valid coupon advertisements stored in the advertisement platform based on content associated with the advertisement, display channel for the advertisement, media type for the advertisement, date the advertisement was consumed by the user, or any keyword related to the advertisement.

A computer system for providing previously published advertisements includes client devices communicatively connected to a search engine and advertisement platform. The client devices generate user queries and transmit the user queries to the search engine. The search engine receives the user queries and communicates with an advertisement platform to receive previously published advertisements that match the user queries.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

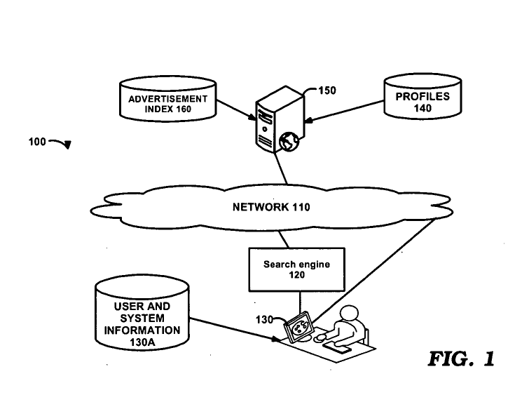

FIG. 1 illustrates an exemplary computing environment 100 for providing previously published advertisements, according to embodiments of the invention. The computing environment 100 includes a network 110, a search engine 120, client device 130, profiles 140, an advertisement platform 150, and an advertisement index 160.

The network 110 is configured to facilitate communication between the client devices 130 and the search engine 120. The network 110 may be a communication network, such as a wireless network, local area network, wired network, or the Internet. In an embodiment, the client devices 130 communicate user queries to the search engine 120 utilizing the network 110. In response, the search engine 120 communicates results that include previously published advertisements that match the user queries to the client devices 130.

The search engine 120 responds to user queries received from the client devices 130. The search engine 120 is communicatively connected to an advertisement platform 150 that stores references to previously published advertisements or the previously published advertisement. The search engine 120 returns the previously published advertisements related to the queries received from the users. In some embodiments, the search engine 120 may provide a listing of Web pages matching the terms included in the user queries along with the previously published advertisements.

The client devices 130 are utilized by a user to generate user queries and to receive query results having previously published advertisements. The client devices 130 include, without limitation, personal digital assistants, smart phones, laptops, personal computers, or any other suitable client computing device. The client devices 130 include a user and system information storage 130A to store user and system information on the client device. In an embodiment, the user and system information storage 130A is a cache of the client device 130. The user information may include search histories, navigation histories, cookies, and passwords. The system information may include internet protocol address, cached Web pages, and system utilization. In some embodiments, the client device 130 may be an advertisement funded client. The advertisement funded client executes applications that are programmed to display advertisements to the user while the users are using the applications. The advertisement funded client may be programmed to generate requests for advertisements based on the data stored in the user and system information storage 130A. The advertisement funded client may communicate directly to the advertisement platform 150 to receive advertisements that match the requests provided by the application. The advertisement funded client receives a result set having the advertisements and selects an advertisement to display to the user while the user interfaces with the application.

The profiles storage 140 stores profiles associated with users that are registered with the advertisement platform 150. In an embodiment, the profiles storage 140 is a database. The profiles storage 140 may be used to target advertisements to users of the advertisement platform 150. The profiles may include user location and demographic data, such as, age, sex, residence, race, and income. The profiles may also include information about user interests and hobbies.

The advertisement platform 150 generates advertisements that are transmitted via network 110 to the client devices 130, which display the advertisements to the user. In certain embodiments, the advertisement platform 150 interfaces with the user via a search engine 120. In alternate embodiments, the advertisement platform 150 interfaces directly with the user via an advertisement funded client. The advertisement platform 150 receives requests for advertisements from the search engine 120 or from the advertisement funded client. The requests received at the advertisement platform 150 are processed to locate user information. In turn, the advertisement platform 150 communicates with the profiles storage 140 to determine whether the user is registered based on the located user information. If the user is registered, the advertisement platform 150 traverses the advertisement index 160 to retrieve advertisements based on the profile data and the requests received by the advertisement platform 150. If the user is unregistered, the advertisement platform 150 traverses the advertisement index 160 to retrieve advertisements based on the requests received by the advertisement platform 150.

In some embodiments, the advertisement platform 150 supplements the previously published advertisements with new advertisements or unpublished advertisements that match the user request and user profile data. The advertisement platform 150 may retrieve the new advertisements or unpublished advertisements from other advertisements indices (not shown) connected to the network 110. In response to a user query or user action, i.e., clicking on show similar advertisements, the advertisement platform 150 traverses the advertisement index 160, which may represent a virtual consolidated index of the other advertisement indices storing new advertisements or unpublished advertisements and an advertisement index storing advertisements previously published in traditional media, to retrieve new advertisements or unpublished advertisements and previously published advertisements. The results including the new advertisements or unpublished advertisements and previously published advertisements are transmitted to the user. The user may request that the advertisement platform 150 refine the results to include advertisements associated with a group of advertisers promoting a particular good or service or the user may request that advertisement platform 150 refine the results to include advertisements from a particular advertiser.

In certain embodiments, the advertisement platform 150 tracks search requests, navigation of advertisements, and keywords to maintain a counts associated with number times a keyword is submitted, number of times an advertisement is viewed, and advertising view frequency. The counts maintained by the advertisement platform 150 may be used to rank the advertisements that are included as search results. In one embodiment, the advertisement platform 150 may use the counts to identify a most popular advertisement and transmit the search results and the most popular advertisement, as a default response, that supplements the search results matching a user query to client device 130.

The advertisement index 160 stores advertisements. In an embodiment, the advertisement index 160 is created based on advertisement logs maintained by media publishers. The media publishers may include advertisement agencies, Internet service providers, search engine providers, radio broadcasters, television broadcasters, newspaper publishers, or magazine publishers. The advertisements may include advertisements that appear in traditional media. In some embodiments, the advertisements are banner advertisements, display advertisements, text, images, animations, graphics, contextual advertisements, search advertisements, radio advertisements, mobile advertisements, television advertisements, or print advertisements that describe a good, service or thing that an advertiser wishes to promote to users. The things described in the advertisements may include events and items from all over the world, from various merchants, and from various distributors. The advertisements are selected by the advertisement platform 150 and transmitted in response to requests received from the search engine 120 or the advertisement funded client. For each advertisement, the advertisement index 160 may store information or editorials regarding features of the advertised good or service, images related to the advertised good or service, movies related to the advertised good or service, and coupons related to the advertised good or service. The advertisement stored by the advertisement index 160 may be configured to redirect a client device 130 to a graphical user interface that is used to traverse the advertisements stored in the advertisement index 160. In an embodiment of the invention, the graphical user interface provides results that attempt to strengthen a brand associated with an advertiser corresponding to the advertisements.

The advertisement index 160 may organize the advertisements based on advertiser, brand, goods, or services. The advertisement index 160 may store attributes for each advertisement. The attributes include, but are not limited to, a date attribute, a time attribute, a keyword attribute, a channel attribute, a title attribute, a media type attribute, a non-advertiser content attribute, a permission attribute, and a competitor exclusion attribute. The date attribute represents dates that the advertisement was published. The time attribute represents times that the advertisement was published or the expiration date of the advertisement. The keyword attribute represents the keywords related to, or in, the advertisement. The channel attribute represents broadcast radio channels or television channels that published the advertisement and the location of the user that consumed the published advertisement. The title attribute represents the name of, or an identifier associated with, the advertisement. The non-advertisement content attribute represent the name of, or an identifier associated with, the non-advertisement content published temporally or spatially proximate to the advertisement. The media type attribute represents the form, such as, print, radio, television, or Internet, of the advertisement. The permission attribute represents the advertiser's consent to reproduction of the advertisement. The competitor exclusion attribute represents an advertiser's preference to avoid publication of a competitor's advertisement temporally or spatially proximate to the advertiser's advertisement.

The advertisement index 160 is populated manually or automatically. The manual process of populating the advertisement index 160 requires an advertiser or media publisher to provide the attributes for each advertisement via a graphical user interface provided by the advertisement platform 150. In some embodiments, a user of client device 130 may directly upload advertisement data to the advertisement index. For instance, a user may write a review for a good or service to provide comments on features of the good or service or upload custom videos related to the good or service. Alternatively, the advertisement index 160 may be populated automatically by processing advertisement logs maintained by the media publishers or the advertisers. The advertisement platform 150 processes each log to extract the attributes and to generate the advertisement index 160.

Accordingly, the computing environment 100 is configured with a search engine 120 that provides previously published advertisements to a user based on results provided by the advertisement platform 150. The advertisement platform 150 traverses the advertisement index 160 based on the requests received from the user. After the search engine 120 generates a prediction of the user's queries, an advertisement platform 150 generates advertisements that should result in a successful transaction with the user. The advertisements provided may evoke nostalgic memories mainly because the advertisements were concise, catchy, or funny. The nostalgic memories may cause the user to enter into a transaction for the good or services promoted by the advertisement. Moreover, advertiser's may use the advertisement index 160 to assess the impact of specific advertisements based on the traffic or transactions generated by user employing the advertisement index 160. The computing environment 100 is configured to provide data mining operations and entertainment. The data mining operations enable an advertiser to monitor trends in an advertising campaign that may be compared to profitability of the good or service promoted in the advertising campaign to measure impact of the advertising campaign. The data mining operations enable a user to render nostalgic advertisements, to locate valid deals and coupons that advertisers are currently offering, and to monitor trends in advertising to determine locations and time periods across years for coupons or deals on goods or services offered by the advertisers. The user's may also use the computing environment 100 to create reviews for goods or services and to receive reviews for goods or services that recommend a good or service or warn of problems related to the good or service.

This computing environment can be used for watching nostalgic advertisements for entertainment purposes.

One of ordinary skill in the art understands and appreciates the computing environment 100 has been simplified for description purposes and alternate operating environments are within the scope and spirit of this description.

In certain embodiments, an advertisement platform receives a request from a search engine or advertisement funded client for advertisements. The advertisement platform processes the request to determine whether the user or client associated with the request is registered. If the user or client is registered the advertisement platform provides advertisements that match a profile associated with the user or client and the request. If the user or client is unregistered the advertisement platform provides advertisements that match the request or a location of the user. In certain embodiments, the location of the user is determined based on the internet protocol address assigned to the user. The advertisement platform selects the advertisements by traversing an advertisement index to locate advertisements that match the request or profile.

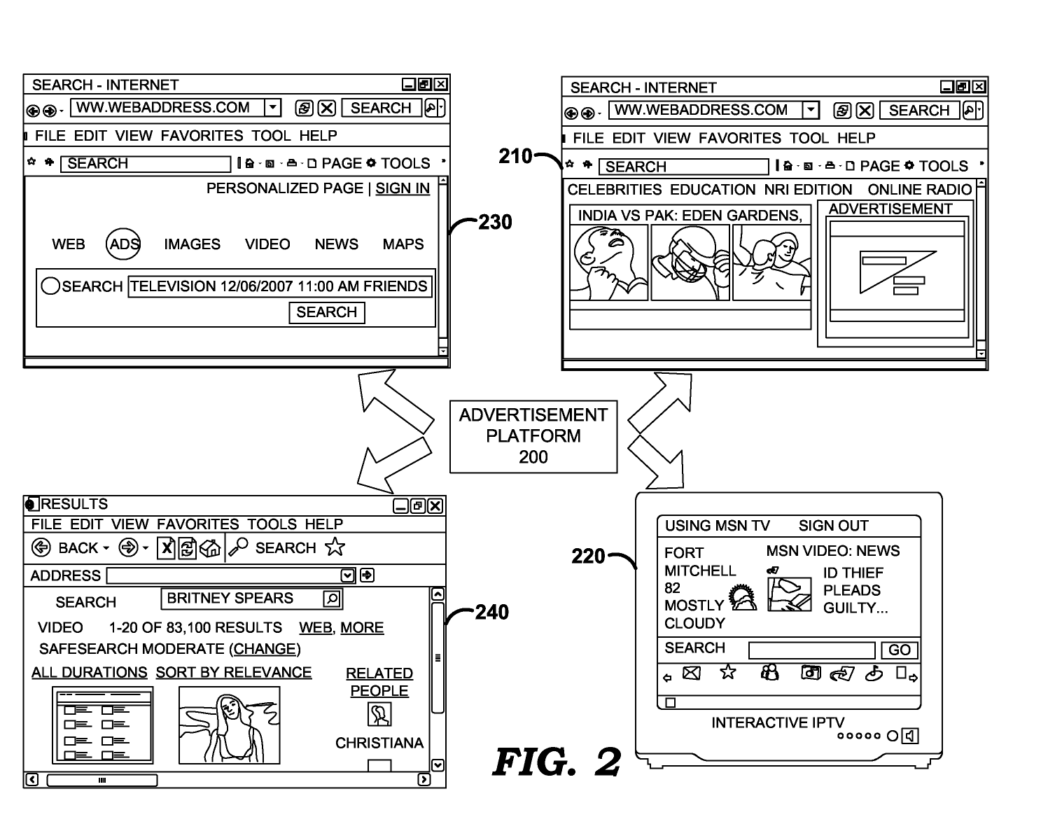

FIG. 2 illustrates an exemplary advertisement platform 200 according to embodiments of the invention. The advertisement platform 200 extracts information for Internet sources 210, television sources 220, print sources (not shown), and radio sources (not shown) to respond to user queries received at a graphical user interface 230 of a search engine that provides results 240 that include previously published advertisements from the Internet sources 210, television sources 220, print sources, and radio sources that match the user queries.

The advertisement platform 200 provides the search engine with the results that match the user queries. In some embodiment, the advertisement platform 200 includes advertisements that match a profile associated with the user that issued queries. The advertisement platform 200 traverses the advertisement index to locate the matches.

The Internet sources 210 provide the advertisement platform 200 with an Internet advertisement log, which includes multiple Web pages. The advertisement platform 200 parses the Internet log to identify the attributes of the Internet advertisements for storage in the advertisement index. For each Web page, the Internet log identifies advertisements and non-advertiser content. The Internet log includes a date and time the Internet advertisement and non-advertiser content were published to an audience associated with the Web page. The non-advertiser content may represent a Internet article, audio, or video that the audience was consuming when the Internet advertisement was published. The attributes from the Internet advertisements are stored in the advertisement index and used to respond to the user search queries.

The television sources 220 provide the advertisement platform 200 with a television log, which includes multiple television channels based on geographic location. The advertisement platform 200 parses the television log to identify the attributes of the television advertisements for storage in the advertisement index. For each television channel, the television log identifies advertisements and non-advertiser content. The television log includes a date and time the television advertisement and non-advertiser content were published to an audience. The non-advertiser content may represent a television situation comedy or drama that the audience was viewing when the television advertisement was displayed. The attributes from the television advertisements are stored in the advertisement index and used to respond to the user search queries.

The print sources provide the advertisement platform 200 with a print advertisement log, which includes advertisements published in newspapers and magazines. The advertisement platform 200 parses the print log to identify the attributes of the print advertisements for storage in the advertisement index. The print advertisement log may identify what section or page of the newspaper or magazine contained the advertisement. The print advertisement log includes the date the print advertisement was published to an audience and the non-advertiser content that was spatially proximate to the print advertisement. In an embodiment, the print advertisement log may be maintained by performing optical character recognition on published print media. The attributes from the print advertisements are stored in the advertisement index and used to respond to the user search queries

The radio sources provide the advertisement platform 200 with a radio advertisement log, which includes multiple radio channels based on geographic location. The advertisement platform 200 parses the radio log to identify the attributes of the radio advertisements for storage in the advertisement index. For each radio channel, the radio log identifies radio advertisements and non-advertiser content. The radio log includes a date and time the radio advertisement and non-advertiser content were published to an audience. The non-advertiser content may represent a radio show or song that the audience was listening to when the radio advertisement was published. The attributes from the radio advertisements are stored in the advertisement index and used to respond to the user search queries

The graphical user interface 230 allows the user to enter search terms of a user query that is submitted to the search engine. In turn, the search engine communicates with the advertisement platform 200. The advertisement platform 200 provides results 240 from the advertisement index that match the terms of the query or the profile associated with the user.

The results 240 include advertisements from the Internet sources 210, television sources 220, print sources, and radio sources. The results 240 are sent from the advertisement platform 200 to the search engine or an advertisement funded client for display to the user. In some embodiments, results 240 include links to Web pages that match the terms of the user query.

In an embodiment, a graphical user interface that interfaces with a search engine is generated in response to user selection of a link embedded in an advertisement currently displayed to the user. The graphical user interface allows the user to request the search engine to locate previously published advertisements from multiple media publishers that are similar to the advertisement currently displayed to the user or that match the terms of a query generated by the user.

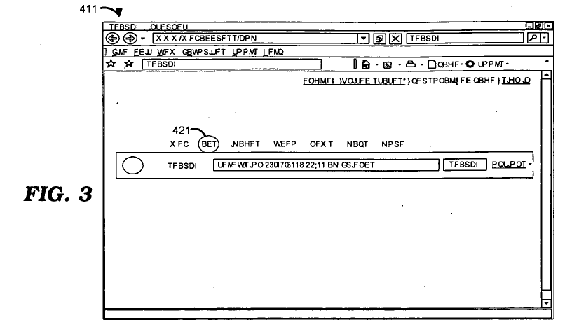

FIG. 3 illustrates an exemplary graphical user interface 300, according to embodiments of the invention. The graphical user interface 300 includes a search field 310. The search field 310 is used to perform a contextual search for the previously published advertisements. The contextual search receives search terms from the user and the graphical user interface 300 is updated with the previously published advertisements that match the search terms.

In an embodiment, the contextual search advertisements are supplemented with display advertisements. The display advertisements are previously published advertisements or newly published advertisements that the advertisement platform sends to the graphical user interface 300 based on profile data that corresponds to the user that issued the query. The profile data may be extracted from log credentials supplied by a user of the graphical user interface 300.

In other embodiments, the graphical user interface 300 is generated when a user of an advertisement funded client selects a link embedded in an advertisement displayed while the user is operating an application on the advertisement funded client. As the user operates the application, the application automatically receives previously published advertisements or newly published advertisements that are displayed with the application's display real estate. The display real estate of the application includes areas within a window created by the application that are not utilized by the application to present application information or access to application functions. The advertisers whose advertisements are displayed within the windows of the application absorb the purchases price of the application so that the application is freely available to a user community.

The search field 310 may receive search terms that correspond to, for example, a media type associated with a previously published advertisement, a content identifier for the television or radio programming that surrounded the previously published advertisement, or the date and time the television or radio programming surrounded the advertisement. Additionally, a user may use the search field 310 to include terms for the radio or television channel that published the previously published advertisement or keywords related to the previously published advertisement.

In an embodiment, the search field 310 is included in a previously published advertisement currently displayed to the user or a newly published advertisement currently displayed to the user. The user may enter the search terms into the search filed 310 that is within the previously published advertisement or the newly published advertisement. In turn, the user will be redirected to the graphical user interface 300 having the search terms provided by the user. The user may initiate the search session at the graphical user interface 300 to locate previously published advertisements that match the search terms provided by the user.

In other embodiments, results generated by a search engine in response to search terms provided by the user include advertisement controls. The advertisement controls allow the user to interface with the advertisements that match the search terms. Additionally, the advertisement controls allow the user to limit the number of advertisements that are included in the results.

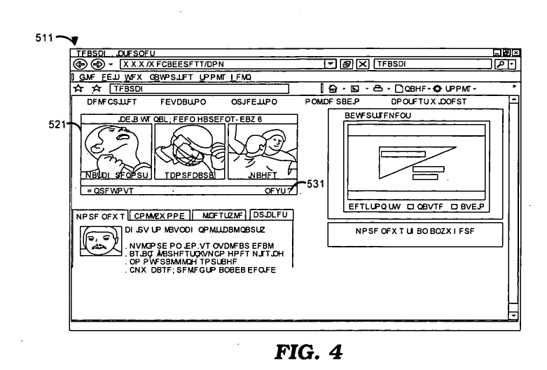

FIG. 4 illustrates an exemplary result set 400 having previously published advertisements 410, according to embodiments of the invention. The previously published advertisements 410 are associated with various advertisement controls 420.

The advertisement controls 420 vary based on the media type associated with the previously published advertisement. For instance, the media type of an advertisement may be video, text, or graphic. The advertisement controls 420 are selected to allow the user to interact with and render the advertisement efficiently. The advertisement control may include play controls, forward controls, stop controls, volume controls, color controls, size controls, or any other suitable rendering control. The advertisement controls 420 may be used to limit or increase the display real estate consumed by the advertisements in the result set 400. The display real estate of the previously published advertisement is the area of the user's screen that the previously published advertisement occupied. In some embodiments, a single previously published advertisement may occupy the entire screen.

A competitor exclusion associated with a previously published advertisement may trigger the advertisement control 420 and prevent advertisements of a competitor from being rendered proximate to the previously published advertisement. The competitor exclusions may be identified by the advertiser of the previously published advertisement or an advertisement platform may detect competitor exclusion based on the temporal or spatial sequence of advertisements published in the traditional media source. When a temporal or spatial series of previously published advertisement are directed to a single advertiser, the advertisement platform tags each of the previously published advertisements in the series of previously published advertisements as having a competitor exclusion.

In some embodiments, the advertisement controls 420 may include buttons or links that generate queries to locate similar advertisements. Additionally, the advertisement control may include categories that are associated with goods or services promoted by the previously published advertisement, categories that are associated with the manufacturer of the good, or categories that are associated with the provider of the service. The result set 400 is updated based on categories selected by the user. For instance, selecting a manufacturer category will update the result set 400 to display all relevant advertisements from the manufacturer followed by all relevant advertisements from its competitors if no competitor exclusions are identified.

In an embodiment, an advertisement platform executes a computer implemented method to generate an advertisement index. The advertisement index is employed by a search engine to locate previously published advertisements that match search terms received by the search engine from a user. The results that match the search terms are provided to the search engine for display to the user.

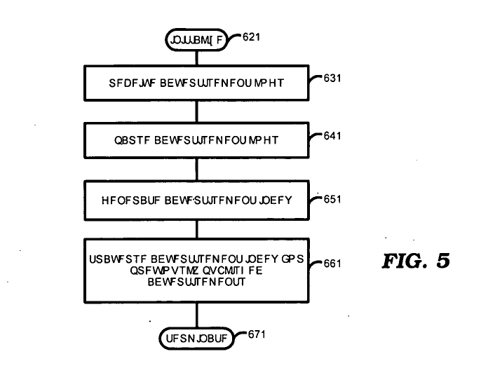

FIG. 5 illustrates an exemplary computer-implemented method for generating an advertisement index that provides result sets having previously published advertisements in response to a user request, according to embodiments of the invention.

The method initializes in step 510. In step 520 an advertisement platform receives advertisement logs having previously published advertisements from media publishers. The media publishers include, but are not limited to, advertisement agencies, Internet service providers, search engine providers, radio broadcasters, television broadcasters, newspaper publishers, or magazine publishers. The previously published advertisements may include text, digital graphics, print graphics, videos, or audio. In turn, the advertisement platform parses the advertisement logs based on goods or services promoted by the previously published advertisements included in the advertisement logs, in step 530. The advertisement logs include an identifier for the non-advertisement content that is published proximate to the previously published advertisement, an identifier for the previously published advertisement, and a time the previously published advertisement was published to an audience. In step 540, the advertisement platform generates an advertisement index to store the previously published advertisements and an identifier for the goods or services corresponding to the previously published advertisements. The advertisement index stores attributes for the previously published advertisements. In step 550, the advertisement platform, in response to a request received from a user, traverses the advertisement index to provide results having the previously published advertisements that match the request. The request may be generated by selecting an embedded link included in an advertisement currently displayed to the user.

In summary, graphical user interfaces, computer-implemented methods, and computing systems receive search terms from a user to provide results that include previously published advertisements that match the search terms. The user of the system may search the previously published advertisements to identify coupon advertisements and the expiration associated with the coupon advertisements. Moreover, the advertisers may receive guaranteed impression among the advertisements of a good or service promoted by the advertiser that captures the interest of the user based on the advertisement controls selected by the user.

The foregoing descriptions of the embodiments of the invention are illustrative, and modifications in configuration and implementation will occur to persons skilled in the art. For instance, while the embodiments of the invention have generally been described with relation to FIGS. 1-5, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the embodiments of the invention are accordingly intended to be limited only by the following claims.

We claim:

1. A computer-implemented method to generate an advertisement index that provides result sets having previously published advertisements in response to a user request, the computer-implemented method comprising:
receiving advertisement logs having previously published advertisements from media publishers;
parsing the advertisement logs based on goods or services promoted by the previously published advertisements included in the advertisement logs;
generating an advertisement index to store the previously published advertisements and an identifier for the goods or services corresponding to the previously published advertisements; and
in response to a request received from a user, traversing the advertisement index to provide results having the previously published advertisements that match the request.

2. The computer-implemented method of claim 1, wherein the previously published advertisements include text, digital graphics, animations, print graphics, videos, or audio.

3. The computer-implemented method of claim 1, wherein the media publishers include advertisement agencies, Internet service providers, search engine providers, radio broadcasters, television broadcasters, newspaper publishers, or magazine publishers.

4. The computer-implemented method of claim 1, wherein the advertisement logs include an identifier for the non-advertisement content that is published proximate to the previously published advertisement, an identifier for the previously published advertisement, and a time the previously published advertisement was published to an audience.

5. The computer-implemented method of claim 1, wherein the advertisement index stores attributes for the previously published advertisements.

6. The computer-implemented method of claim 1, wherein the request is generated by selecting an embedded link included in an advertisement currently displayed to the user.

7. A computer system to generate result sets having previously published advertisements based on a request received from a user, the computer system comprising:
an advertisement index configured to organize the previously published advertisements based on media publisher;
a search engine to receive the search terms and to generate results sets that include the previously published advertisements; and
an advertisement platform to provide the previously published advertisements matching the search terms and profile data to the search engine and new advertisements matching the search terms and profile data to the search engine.

8. The computer system of claim 7, wherein the search terms are generated by selecting an embedded link included in an advertisement currently displayed to the user.

9. The computer system of claim 7, wherein the search terms are generated based on a query received from the user.

10. The computer system of claim 9, wherein the query includes an identifier for non-advertiser content and a date when the user consumed the non-advertiser content.

11. The computer system of claim 7, wherein the search terms include identifiers for non-advertisement content, display channel, media, time, or keyword.

12. The computer system of claim 7, wherein the advertisement index identifies competitor exclusions associated with the previously published advertisements and associated media publishers.

13. The computer system of claim 12, wherein a full page previously published advertisement or a series of previously published advertisements for goods or services provided by a single advertiser occupying consecutive advertisement timeslots or proximate advertisement placeholders are published by the associated media publishers to indicate competitor advertisements are excluded from publication with the corresponding previously published advertisements for the single advertiser.

14. A graphical user interface generated for display to a user in response to a request received from the user, the graphical user interface comprising:
a search field to receive user search terms for previously published advertisements consumed by the user;
a display area to provide results that include previously published advertisements that match the search terms; and
advertisement controls to limit the results based on categories corresponding to the goods and services associated with the previously published advertisements.

15. The graphical user interface of claim 14, wherein the search terms include identifiers for non-advertisement content and a date the non-advertisement content was consumed by the user.

16. The graphical user interface of claim 15, wherein the non-advertisement content was published spatially or temporally proximate to previously published advertisements consumed by the user.

17. The graphical user interface of claim 14, wherein the advertisement controls include competitor exclusions.

18. The graphical user interface of claim 17, wherein a full page previously published advertisement or a series of previously published advertisements for goods or services provided by a single advertiser occupying consecutive advertisement timeslots or proximate advertisement placeholders are published by the associated media publishers to indicate competitor advertisements are excluded from publication with the corresponding previously published advertisements for the single advertiser.

19. The graphical user interface of claim 14, further comprising:
a Web results display area to provide Web results that match the search terms; and
a default response area that provides an advertisement that is identified as a popular advertisement.

20. The graphical user interface of claim 19, wherein the Web results display area is separate from the display area that provides the previously published advertisements that match the search terms.
